(19) United States
(12) Patent Application Publication
(10) Pub. No.: US 2019/0369706 A1
(43) Pub. Date: Dec. 5, 2019

(54) BURST-RESPONSIVE WIRELESS DOWNLOAD PACKET MANAGEMENT FOR REDUCING PROCESSING WORKLOAD LATENCY AND POWER CONSUMPTION

(71) Applicant: QUALCOMM INCORPORATED, SAN DIEGO, CA (US)

(72) Inventors: Vamsi Dokku, San Diego, CA (US); Alok Mitra, San Diego, CA (US)

(21) Appl. No.: 15/995,940

(22) Filed: Jun. 1, 2018

(51) Int. Cl. G06F 1/32; G06F 13/16; G06F 9/30; G06F 13/28

(52) U.S. Cl. CPC G06F 1/3234; G06F 13/161; G06F 12/0802; G06F 9/3004; G06F 13/28; G06F 13/1668

(57) ABSTRACT

Systems, methods, and computer programs are disclosed for processing wireless download data in a portable communication device. An embodiment of a method comprises a wireless communication processor receiving incoming packet data via a wireless communication network. The wireless communication processor generates and inserts burst metadata into a burst of packets comprising a portion of the incoming packet data. The burst metadata specifies one or more workload parameters associated with the burst of packets. The wireless communication processor transmits the burst metadata and the burst of packets to a central processing unit (CPU). The CPU initiates an adjustment of an operating parameter for processing the burst of packets in accordance with the one or more workload parameters in the burst metadata.

### DESCRIPTION OF THE RELATED ART

Portable communication devices (e.g., cellular telephones, smart phones, tablet computers, portable game consoles, wearable devices, and other battery-powered devices) and other computing devices continue to offer an ever-expanding array of features and services, and provide users with unprecedented levels of access to information, resources, and communications. To keep pace with these service enhancements, such devices have become more powerful and more complex. Portable communication devices now commonly include a system on chip (SoC) comprising a plurality of processing devices embedded on a single substrate, which may read data from and store data in an external system memory comprising volatile memory (e.g., double data rate (DDR) dynamic random access memory (DRAM)) via a high-speed bus.

The SoC processing devices may comprise one or more central processing units (CPUs), a wireless communication processor (e.g., a modem processor), and a dynamic clock and voltage scaling (DCVS) controller. The modem processor is configured to manage data communications with a wireless wide area network (WWAN) supporting various wireless technologies (fourth generation (“4G”), fifth generation (“5G”), etc.). The DCVS controller is configured to selectively adjust the frequency and/or voltage applied to the SoC processing components to yield a desired performance and/or power efficiency characteristics.

In conventional wireless data communication solutions, the frequency of the CPUs may be adjusted in a step-wise fashion while load is evaluated at a predetermined sampling interval (e.g., every few msec). However, because WWAN download data is inherently bursty, it is difficult for the CPU and DVCS controller/scheduler to react quickly enough to adjust to the new workload. This delayed reaction time to the increased workload frequently results in packets getting dropped and can result in higher latency times, which ultimately translate to poor user experience. This problem will only get worse with the adoption and advancement of wireless standards (e.g., 5G) where the data rates are significantly higher and there is a need for very low latency and high reliability requirements. Furthermore, not processing WWAN workloads with the optimal frequency may also result in using the CPU core for longer durations, which can result in more power consumption.

Accordingly, there is a need for improved systems and methods for processing wireless download data in a portable communication device.

### SUMMARY OF THE DISCLOSURE

Systems, methods, and computer programs are disclosed for processing wireless download data in a portable communication device. An embodiment of a method comprises a wireless communication processor receiving incoming packet data via a wireless communication network. The wireless communication processor generates and inserts burst metadata into a burst of packets comprising a portion of the incoming packet data. The burst metadata specifies one or more workload parameters associated with the burst of packets. The wireless communication processor transmits the burst metadata and the burst of packets to a central processing unit (CPU). The CPU initiates an adjustment of an operating parameter for processing the burst of packets in accordance with the one or more workload parameters in the burst metadata.

An embodiment of a system for processing wireless download data in a portable communication device comprises a central processing unit (CPU), a wireless communication processor, and a dynamic clock and voltage scaling (DCVS) controller electrically coupled via a system bus. The wireless communication processor is configured to: receive incoming packet data via a wireless communication network; generate and insert burst metadata into a burst of packets comprising a portion of the incoming packet data that specifies one or more workload parameters associated with the burst of packets; and transmit the burst metadata and the burst of packets to the CPU. The DCVS controller is configured to adjust a frequency of the CPU for processing the burst of packets in accordance with the one or more workload parameters in the burst metadata.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for providing burst-responsive wireless download packet management in a portable communication device to reduce processing workload latency and power consumption.

FIG. 2 is combined block/flow diagram illustrating the general operation of the system of FIG. 1.

FIG. 3 is a flowchart illustrating an embodiment of a method implemented in the system of FIG. 1 for providing burst-responsive wireless download packet management to reduce processing workload latency and power consumption.

FIG. 4 is a table illustrating exemplary data for an embodiment of a wireless download packet burst.

FIG. 5 is a graph illustrating how packet bursts may cause queue build-up at the wireless communication processor.

FIG. 6 is a graph illustrating potential problems of adjusting the CPU frequency level in a packet burst scenario without burst-responsive packet download manager module 113.

FIG. 7 is a block diagram of an exemplary embodiment of a portable communication device for incorporating the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”), fourth generation (“4G”), fifth generation (“5G”) and other wireless technology, greater bandwidth availability has enabled more portable computing devices with a greater variety of wireless capabilities.

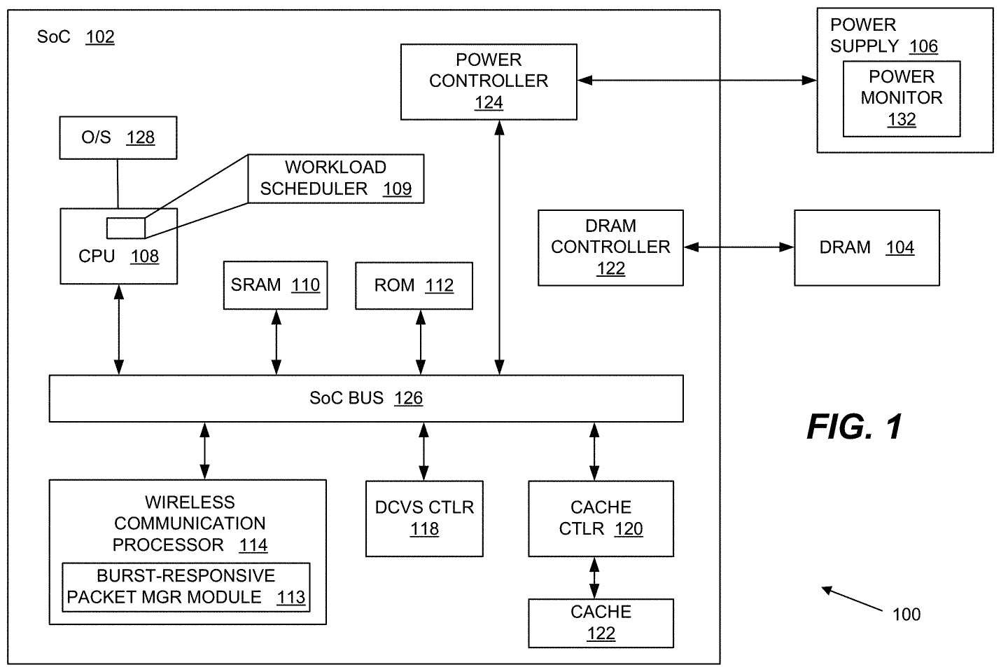

FIG. 1 illustrates an embodiment of a system 100 for providing burst-responsive wireless download packet management in a portable communication device. The system 100 comprises a system on chip (SoC) 102 electrically coupled to an external system memory via a memory bus. In the embodiment of FIG. 1, the external system memory comprises volatile memory, such as, for example, dynamic random access memory (DRAM) 104. DRAM 104 may comprise a double data rate (DDR) synchronous DRAM configured to operate at two or more dynamically selectable frequencies. The memory bus, which electrically couples the SoC 102 to DRAM 104, may comprise a DDR bus supporting any of the following: low power DDR (LPDDR), LPDDR2, LPDD3, DDR2, DDR3, etc. It should be appreciated that system 100 may be incorporated in various types of computing devices, including a personal computer, a workstation, a server, a laptop computer, a gaming console, or a portable communication device (PCD), such as a cellular telephone, a smartphone, a portable digital assistant (PDA), a portable game console, a tablet computer, a fitness computer, and a wearable device (e.g., a sports watch, a fitness tracking device, etc.) or other battery-powered devices with a wireless connection or link.

As illustrated in FIG. 1, SoC 102 comprises various on-chip components electrically coupled via SoC bus 126. In the embodiment of FIG. 1, SoC 102 comprises one or more memory clients (e.g., central processing unit(s) (CPU) 108 supporting a high-level operating system (O/S) 128, graphics processing unit(s) (GPU), digital signal processor(s) (DSPs)), a static random access memory (SRAM) 110, read only memory (ROM) 112, a DRAM controller 122, a power controller 124, a dynamic clock and voltage scaling (DCVS) controller 118, a cache controller 120, and a wireless communication processor 114 interconnected via SoC bus 115.

Wireless communication processor 114 is configured to manage communications with one or more wireless networks, including, for example, a wireless wide area network (WWAN) and/or a wireless local area network (WLAN). As known in the art, WWAN may support various wireless technology (e.g., third generation (“3G”), fourth generation (“4G”), fifth generation (“5G”), and other wireless technology). In an embodiment, wireless communication processor 114 comprises a modem processor.

Power controller 124 is electrically coupled to a power supply 106 via a power control bus, which comprises a power monitor 132 configured to measure energy usage associated with the SoC 102 and the DRAM 104 and, thereby, monitor device power consumption.

DCVS controller 118 is configured to implement various DCVS techniques. As known in the art, the DCVS techniques involve selectively adjusting the frequency and/or voltage applied to the SoC components (e.g., CPU 108, power controller 124, DRAM controller 122, cache controller 120, and other hardware devices) to yield desired performance and/or power efficiency characteristics.

DRAM controller 122 is configured to manage communication between SoC 102 and DRAM 104, including read and/or write transactions from memory clients residing on SoC 102.

Cache controller 120 is configured to manage a system cache 122, which stores data so future requests for data may be served faster. In an embodiment, cache 122 may comprise a multi-level hierarchy (e.g., level one (L1) cache, level two (L2) cache, etc.) with a “last level” (L3) cache that may be shared among the SoC processing devices.

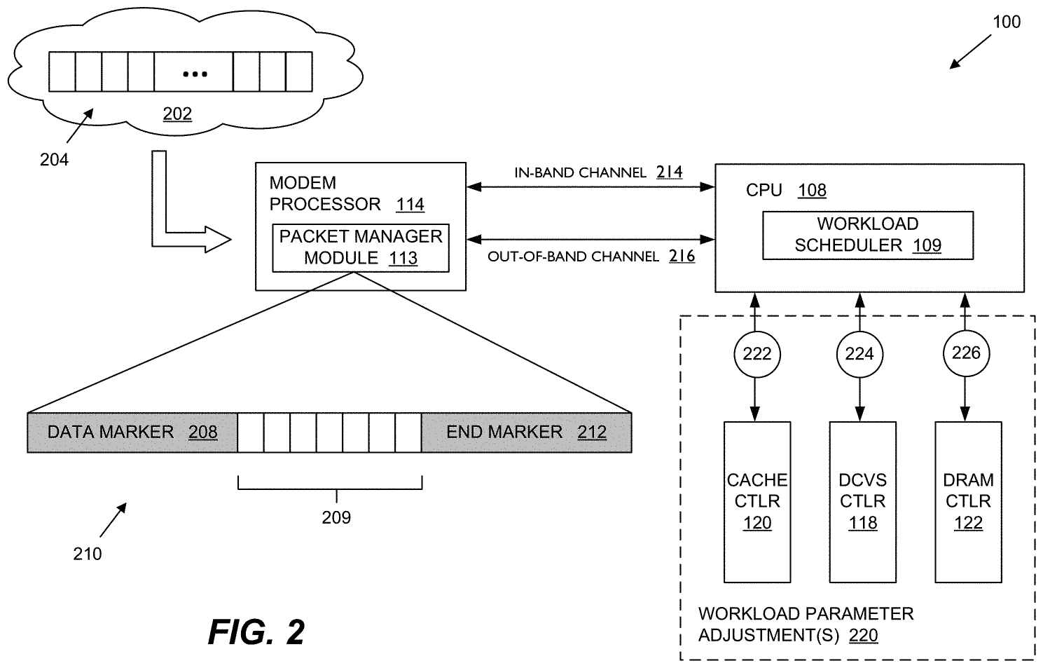

Referring to FIG. 2, the system 100 comprises specially-configured modules associated with wireless communication processor 114 and CPU 108, which comprise the logic and/or functionality for enabling power-efficient and/or latency-resistant handling of incoming packet data associated with a wireless download. In the embodiment of FIG. 2, wireless communication processor 114 comprises burst-responsive packet manager module 113 and CPU 108 comprises a workload scheduler 109. Burst-responsive packet manager module 113 and workload scheduler 109 comprise dedicated functionality at separate SoC processing components (i.e., wireless communication processor 114 and CPU 108, respectively), which are operatively coupled to enable system 100 to reduce processing workload latency and/or power consumption in connection with a wireless download. In this regard, it should be appreciated that the term “wireless download” refers to the situation in which one or more files are received from a remote device, server, etc. via the wireless communication network 202 as incoming packet data 204. It should be appreciated that the wireless download may be associated with various use cases, including, for example, a file download (e.g., a video to be watched), live streaming of a video, movie, or a video conference, as well as augmented reality (AR) or virtual reality (VR) use cases.

As illustrated in FIG. 2, incoming packet data 204 associated with a wireless download comprises a plurality of packets 1, 2, 3, 4 . . . (n−2), (n−1), n. As known in the art, the incoming packets 1-n comprise a formatted unit of data carried by the packet-switched wireless communication network 202. Each packet comprises formatting elements for distinguishing user data (generally referred to as the packet “payload”) from control and other information (e.g., packet headers and trailers). Control information provides data for delivering the payload, such as, source and destination network addresses, error detection codes, and sequencing information. It should be appreciated that the incoming packet data 204 may support various communication protocols. In an embodiment, the incoming packet data 204 comprises Internet Protocol (IP) packets commonly used for delivering packets from a source host to a destination host based on IP addresses in the packet headers.

In connection with the incoming download packet data 204, wireless communication processor 114 generally performs certain dedicated packet management functions via burst-responsive packet management module 113, and CPU 108 generally schedules and processes the workload generated by the incoming download packet data 204 as they are received from wireless communication processor 114. In other words, as known in the art, wireless communication processor 114 performs “packet processing” whereas CPU 108 performs “workload processing”. In general, burst-responsive packet manager module 113 in wireless communication processor 114 processes incoming packets from various services and, prior to transmitting to CPU 108, generates and inserts burst metadata into a packet burst 209 comprising a portion of the incoming packet data 204. As described below in more detail, the burst metadata may specify one or more workload parameters associated with the packet burst 209, which may be transmitted with the packet data to CPU 108. Workload scheduler 109 interprets the burst metadata to evaluate a current workload and, in response, take steps to address an upcoming increase in workload by, for example, adjusting one or more operating parameters for processing the packet burst 209.

During a wireless download, the rate of packets (i.e., packets/msec) at wireless communication processor 114 can vary significantly, resulting in packet burst(s) 209 that can lead to undesirable results, such as, dropped packets, increased workload latency, and power inefficiencies. For example, in conventional wireless device architectures, the frequency of the CPU(s) used to handle the workload generated by incoming download packet data may be adjusted in a step-wise fashion while the load is evaluated at a predetermined sampling interval (e.g., every few msec). Because wireless download data is inherently bursty, the sampling interval of the CPU and DCVS controller/scheduler may be insufficient to react quickly enough to adjust to new workload. This delayed reaction time to exponentially increased workload generated by incoming download packet data may result in packets getting dropped and can result in higher latency times, which ultimately translate to poor user experience. This problem will only get worse with the adoption and advancement of wireless standards (e.g., 5G) where the data rates are significantly higher and there is a need to meet very low latency and high reliability requirements. Furthermore, not processing workloads with the optimal frequency may also result in using the core for longer durations, which can result in more power consumption.

FIG. 2 illustrates the interoperation of the packet management and workload scheduling/processing functionality performed by wireless communication processor 114 and CPU 108, respectively. As illustrated in FIG. 2, the wireless communication Qualcomm Ref. No. 180212 processor 114 receives the incoming download packet data 204 via the wireless communication network 202. Prior to transmitting the IP packet data to CPU 108, burst-responsive packet manager module 113 in the wireless communication processor 114 may determine various workload characteristics of the incoming download packet data 204. The workload characteristics may be related to any of the following, or other types of information: the expected “burstiness” of the packets, a size of packet payload(s) (bytes), whether the data is time sensitive (e.g., real-time vs. non-real-time), a file size associated with the wireless download, a calculated or recommended workload parameter (MIPs), a download duration, etc.

In this manner, burst-responsive download packet manager module 113 may determine, as incoming packets are received, when a packet burst scenario (i.e., packet burst 209) is likely or has occurred, which may lead to dropped packets, increased workload latency, and/or power inefficiencies based on a current workload operating parameter. The current workload operating parameter may involve any of the following, or other parameters: a current CPU frequency, a current DDR frequency, a cache frequency, a current DCVS voltage/frequency setting, a cache state, etc.).

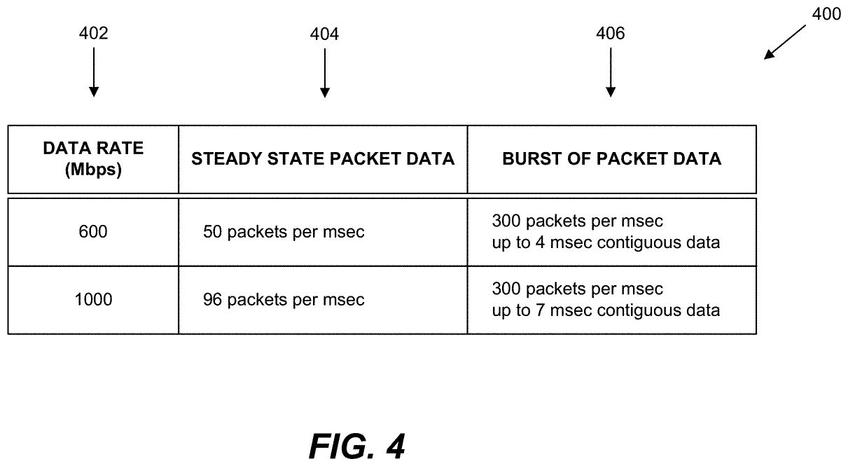

FIG. 4 is a table 400 illustrating exemplary values for an embodiment of a packet burst scenario for a 4G LTE wireless communication network. Column 402 specifies LTE data rates of 600 Mbps and 1000 Mbps. Column 404 specifies packet data rates of 50 packets/msec and 96 packets/msec for steady state, or non-packet-burst scenario, at each of the LTE data rates. Column 406 specifies exemplary values for a packet burst scenario. For example, at a LTE data rate of 600 Mbps, a packet burst scenario may occur when the rate of incoming packets exceeds a threshold of 300 packets/msec with up to 4 msec of contiguous data. At a LTE data rate of 1000 Mbps, a packet burst scenario may occur when the rate of incoming packets exceeds a threshold of 300 packets/msec with up to 7 msec of contiguous data. It should be appreciated that the values in FIG. 4 are merely for exemplary purposes.

Regardless of the workload characteristics and/or specific threshold values, in response to a packet burst scenario, burst-responsive download packet manager module 113 may perform certain specialized packet management functions before transmitting the IP packet data to CPU 108 for workload scheduling and processing. As illustrated in FIG. 2, burst-responsive download packet manager module 113 may configure and insert an information/data marker 208 in IP packet data 210 associated with packet burst 209. In general, information/data market 208 comprises burst metadata specifying one or more workload parameters associated with packet burst 209. In an embodiment, the burst metadata may comprise a number of bytes, a number of packets in a burst, a rate of received packets, etc. The burst metadata may be inserted into any desirable packet element based on the particular protocol, including, for example, a packet header.

Regardless the particular content and/or format of the burst metadata, the information/data marker 208 (i.e., the burst metadata) and the IP packet data 210 associated with packet burst 209 are transmitted to CPU 108. In one embodiment, the information/data marker 208 is transmitted in a packet header with IP packet data 210 via an in-band channel 214. It should be appreciated, however, that the burst metadata may also be separately transmitted to CPU 108 via the in-band channel 214 or via a separate out-of-band channel 216.

As further illustrated in FIG. 2, CPU 108 receives the information/data marker 208 and IP packet data 210 from wireless communication processor 106. The burst metadata specified in information/data marker 208 may be used to initiate an adjustment of one or more current workload operating parameters to perform workload processing in a more power-efficient manner. In one example (reference numeral 224), the DCVS controller 118 may configure a CPU frequency to more aggressively support the packet burst scenario. It should be appreciated that this may help prevent dropping any incoming packets on CPU 108 and may improve both performance and/or power.

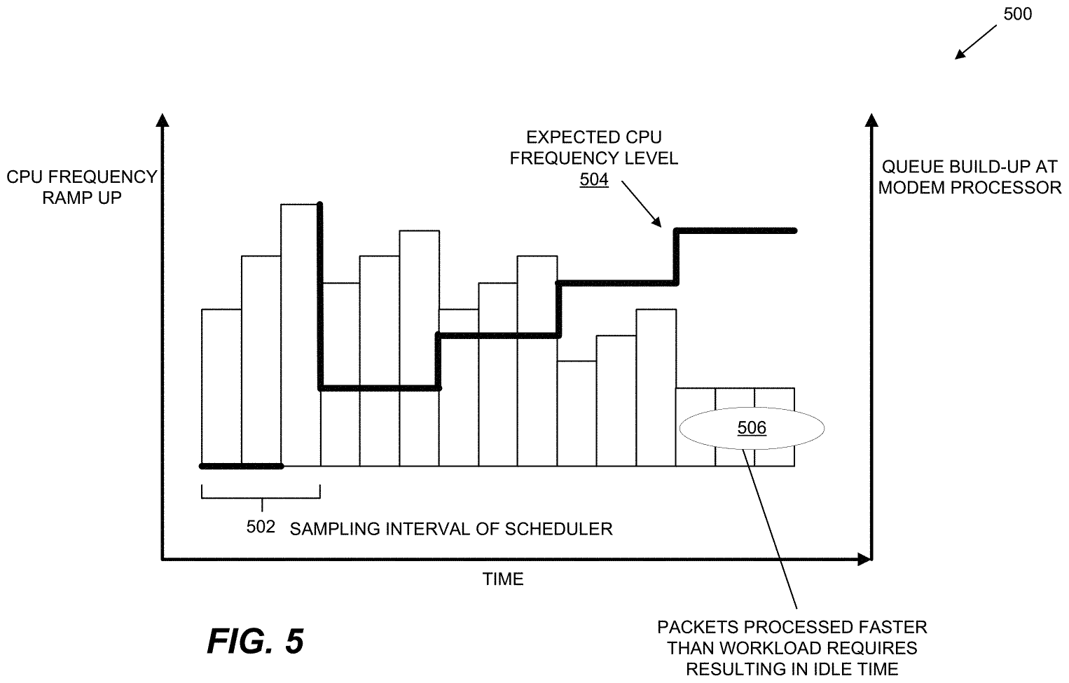

For purposes of illustrating remedial adjustment of the CPU frequency in response to the burst metadata, the graph 500 in FIG. 5 illustrates how packet queues for exemplary WWAN download data may otherwise build up at wireless communication processor 113 until CPU core frequencies are configured to an expected level (line 504) based on the limitations of the sampling interval 502. This queue build up could otherwise cause drops/retransmissions as well as added latencies. When the expected core frequency (line 504) is finally achieved, bursty traffic from wireless communication processor 113 may be processed fast enough, but possibly leaving idle time at CPU 108 due to the final three packets (reference numeral 506) being processed faster than the current workload requires.

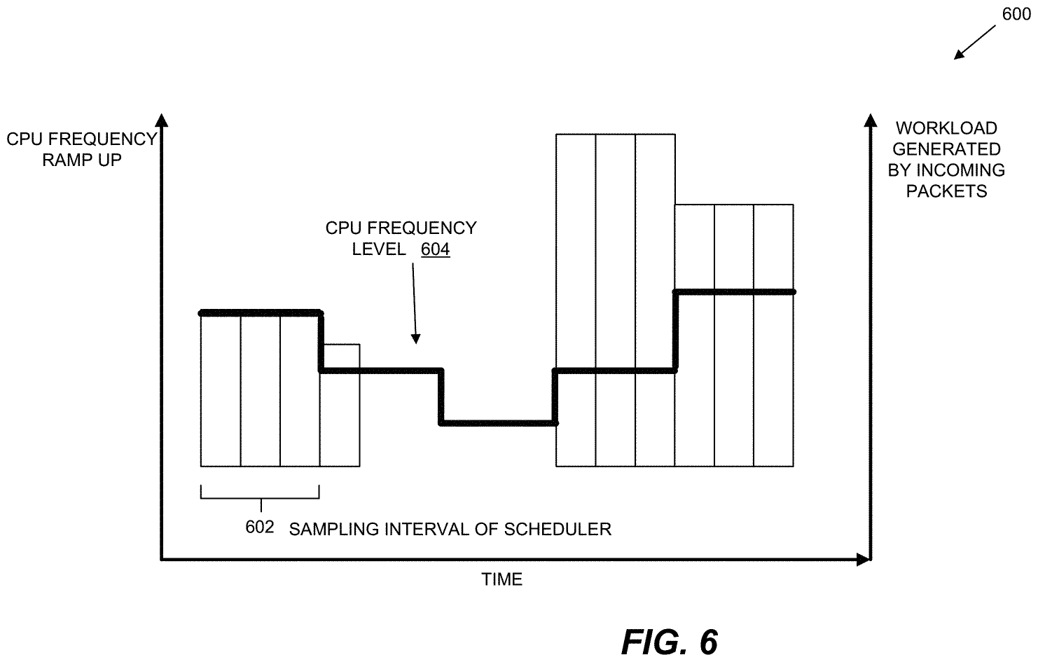

Another example of the benefits of remedial adjustment of the CPU frequency in response to the burst metadata is illustrated in FIG. 6. The graph 600 in FIG. 6 shows some of the potential problems of adjusting the CPU frequency level (line 604) in a packet burst scenario without burst-responsive packet download manager module 113. In this comparative example, the CPU frequency level (line 604) may be adjusted to varying workloads generated by bursty incoming WWAN packets, which may result in instances where workload dips significantly before a burst of incoming packets increases the workload, creating a situation where the increased workload is processed by a lower than optimal CPU frequency level.

As further illustrated in FIG. 2, at the end of a packet burst scenario, burst-responsive download packet manager 113 may configure and transmit another information/data marker (end marker 212) to CPU 108 indicating a return to a steady state. In response to receiving end marker 212, DCVS controller 118 may, for example, downgrade the CPU frequency in such a manner to immediately benefit from any idle times.

As illustrated at reference numeral 226, another workload adjustment may involve reducing the frequency of a DDR bus electrically coupling the DRAM 104 to DRAM controller 122. Yet another workload adjustment may involve adjusting the state and/or performance of the cache 122 (reference numeral 222). As known in the art, a last-level (L3) cache can significantly improve performance. L3 cache may be power collapsed whenever CPU 108 is in a power-saving mode. In response to the packet burst scenario and receiving information/data marker 208, cache controller 120 may wake-up the L3 cache, which may reduce the additional latency/delay of waking up L3 cache from the cold when a burst of packets are received from wireless communication processor 113. In this regard, information/data marker 208 may also provide, for example, burst metadata related to incoming packet load details that may allow CPU 108 (or cache controller 120) to configure the L3 cache frequency to meet workload demand.

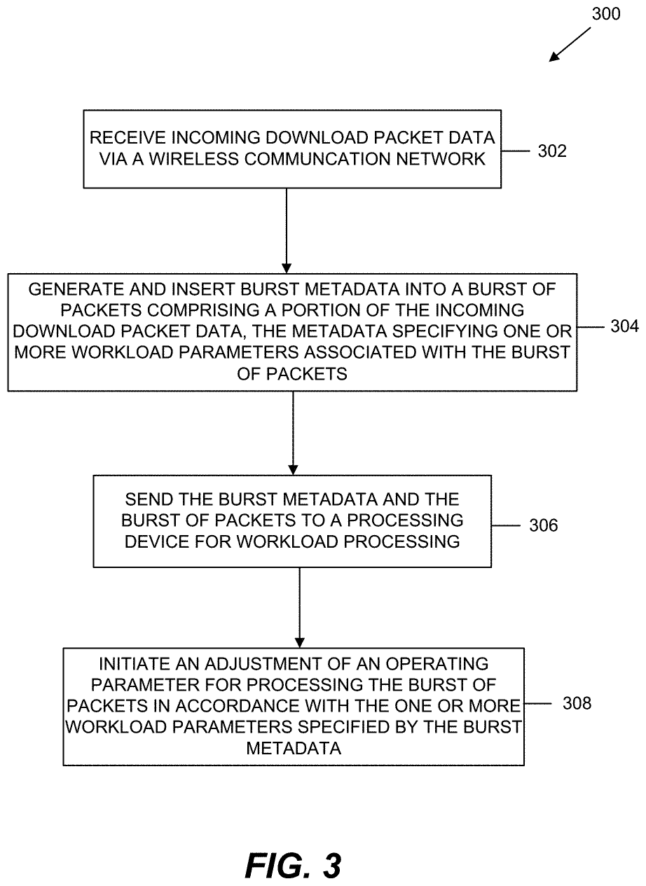

FIG. 3 is a flowchart illustrating an embodiment of a method 300 implemented in the system 100 for providing burst-responsive wireless download packet management to reduce processing workload latency and/or power consumption. At block 302, wireless communication processor 114 receives incoming download packet data 204 via a wireless communication network 202. At block 304, before transmission of IP packet data to CPU 108, wireless communication processor 114 (e.g., burst-responsive download packet manager module 113) may generate and insert burst metadata into a packet burst 209 comprising a portion of the incoming download packet data 204. As mentioned above, the burst metadata may specify one or more workload parameters. At block 306, the packet burst 209 and the burst metadata may be sent to CPU 108 for workload processing. At block 308, the CPU 108 (or workload scheduler 109) may initiate an adjustment of one or more operating parameters for processing the packet burst 209 in accordance with the one or more workload parameters specified in the burst metadata.

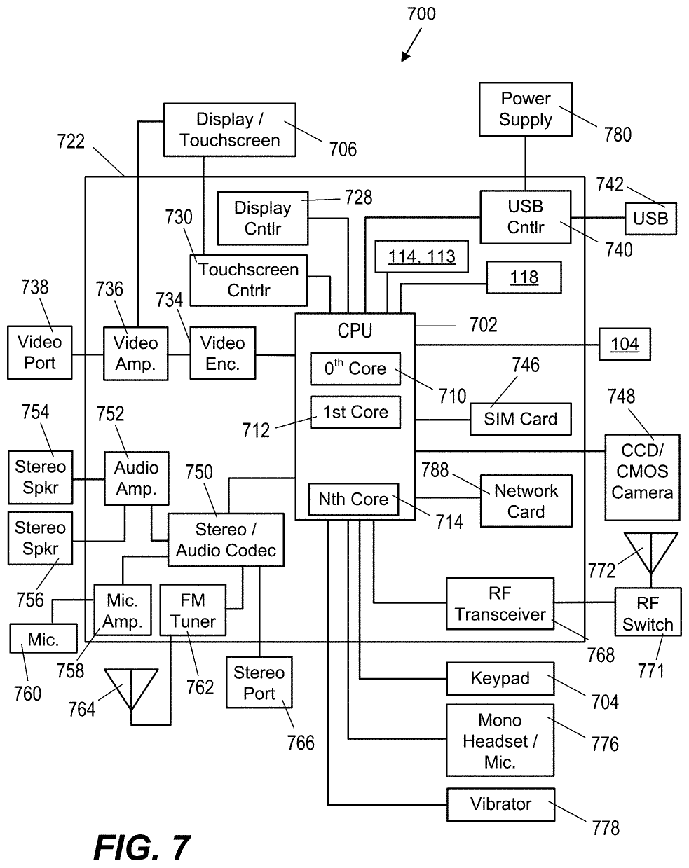

As mentioned above, the system 100 may be incorporated into any desirable computing system. FIG. 7 illustrates the system 100 incorporated in an exemplary portable communication device (PCD) 700. It will be readily appreciated that certain components of the system 100 may be included on the SoC 722 while other components (e.g., DRAM 104) may be external components coupled to the SoC 722. The SoC 722 may include a multicore CPU 702. The multicore CPU 702 may include a zeroth core 710, a first core 712, and an Nth core 714. One of the cores may comprise, for example, a graphics processing unit (GPU) with one or more of the others comprising the CPU 702.

A display controller 728 and a touch screen controller 730 may be coupled to the CPU 702. In turn, the touch screen display 706 external to the on-chip system 722 may be coupled to the display controller 828 and the touch screen controller 730.

FIG. 7 further shows that a video encoder 734, e.g., a phase alternating line (PAL) encoder, a sequential color a memoire (SECAM) encoder, or a national television system(s) committee (NTSC) encoder, is coupled to the multicore CPU 702. Further, a video amplifier 736 is coupled to the video encoder 734 and the touch screen display 706. Also, a video port 738 is coupled to the video amplifier 736. As shown in FIG. 7, a universal serial bus (USB) controller 740 is coupled to the multicore CPU 702. Also, a USB port 742 is coupled to the USB controller 740.

Further, as shown in FIG. 7, a digital camera 748 may be coupled to the multicore CPU 702. In an exemplary aspect, the digital camera 748 is a charge-coupled device (CCD) camera or a complementary metal-oxide semiconductor (CMOS) camera.

A stereo audio coder-decoder (CODEC) 750 may be coupled to the multicore CPU 702. Moreover, an audio amplifier 752 may be coupled to the stereo audio CODEC 750. In an exemplary aspect, a first stereo speaker 754 and a second stereo speaker 756 are coupled to the audio amplifier 752. FIG. 7 shows that a microphone amplifier 758 may be also coupled to the stereo audio CODEC 750. Additionally, a microphone 760 may be coupled to the microphone amplifier 758. In a particular aspect, a frequency modulation (FM) radio tuner 762 may be coupled to the stereo audio CODEC 750. Also, an FM antenna 764 is coupled to the FM radio tuner 762. Further, stereo headphones 766 may be coupled to the stereo audio CODEC 750.

FIG. 7 further illustrates that a radio frequency (RF) transceiver 768 may be coupled to the multicore CPU 702. An RF switch 770 may be coupled to the RF transceiver 768 and an RF antenna 772. A keypad 704 may be coupled to the multicore CPU 702. Also, a mono headset with a microphone 776 may be coupled to the multicore CPU 702. Further, a vibrator device 778 may be coupled to the multicore CPU 702.

FIG. 7 also shows that a power supply 780 may be coupled to the on-chip system 722. In a particular aspect, the power supply 780 is a direct current (DC) power supply that provides power to the various components of the PCD 700 that require power. Further, in a particular aspect, the power supply is a rechargeable DC battery or a DC power supply that is derived from an alternating current (AC) to DC transformer that is connected to an AC power source.

FIG. 7 further indicates that the PCD 700 may also include a network card 788 comprising, for example, burst-responsive packet manager module 114 that may be used to access a wireless data network (e.g., a wide area network, a local area network, a personal area network, or any other network). The network card 788 may be a Bluetooth network card, a WiFi network card, a personal area network (PAN) card, a personal area network ultra-low-power technology (PeANUT) network card, a television/cable/satellite tuner, or any other network card well known in the art. Further, the network card 788 may be incorporated into a chip, i.e., the network card 788 may be a full solution in a chip, and may not be a separate network card 788.

As depicted in FIG. 7, the touch screen display 706, the video port 738, the USB port 742, the camera 748, the first stereo speaker 754, the second stereo speaker 756, the microphone 760, the FM antenna 764, the stereo headphones 766, the RF switch 770, the RF antenna 772, the keypad 774, the mono headset 776, the vibrator 778, and the power supply 780 may be external to the on-chip system 722.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for processing wireless download data in a portable communication device, the method comprising:
a wireless communication processor receiving incoming packet data via a wireless communication network;
the wireless communication processor generating and inserting burst metadata into a burst of packets comprising a portion of the incoming packet data, the burst metadata specifying one or more workload parameters associated with the burst of packets;
the wireless communication processor transmitting the burst metadata and the burst of packets to a central processing unit (CPU); and
the CPU initiating an adjustment of an operating parameter for processing the burst of packets in accordance with the one or more workload parameters in the burst metadata.

2. The method of claim 1, wherein the wireless communication processor comprises a modem processor and the wireless communication network comprises a wireless wide area network.

3. The method of claim 1, wherein the burst of packets has a predetermined rate of received packets.

4. The method of claim 1, wherein the one or more workload parameters comprises one or more of a time-sensitivity parameter, a data size, a recommended number of instructions per second, and a download duration.

5. The method of claim 1, wherein the burst metadata is transmitted to the CPU via an out-of-band channel and the burst of packets is transmitted to the CPU via an in-band channel.

6. The method of claim 1, wherein the operating parameter for processing the burst of packets comprises one of a CPU frequency and a memory bus frequency.

7. The method of claim 6, further comprising increasing one of the CPU frequency and the memory bus frequency.

8. The method of claim 1, wherein the CPU initiating the adjustment of the operating parameter for processing the burst of packets comprises:
waking up a system cache; and
increasing the system cache frequency.

9. A system for processing wireless download data in a portable communication device, the system comprising:
means for receiving incoming packet data via a wireless communication network;
means for generating and inserting burst metadata into a burst of packets comprising a portion of the incoming packet data, the burst metadata specifying one or more workload parameters associated with the burst of packets;
means for transmitting the burst metadata and the burst of packets to a central processing unit (CPU); and
means for initiating an adjustment of an operating parameter for processing the burst of packets in accordance with the one or more workload parameters in the burst metadata.

10. The system of claim 9, wherein the means for receiving the incoming packet data via the wireless communication network comprises a modem processor.

11. The system of claim 9, wherein the burst of packets has a predetermined rate of received packets.

12. The system of claim 9, wherein the one or more workload parameters comprises one or more of a time-sensitivity parameter, a data size, a recommended number of instructions per second, and a download duration.

13. The system of claim 9, wherein the burst metadata is transmitted to a central processing unit (CPU) via an out-of-band channel and the burst of packets is transmitted to the CPU via an in-band channel.

14. The system of claim 9, wherein the operating parameter for processing the burst of packets comprises one of a processor frequency and a memory bus frequency.

15. The system of claim 9, wherein the means for initiating the adjustment of the operating parameter for processing the burst of packets comprises a dynamic clock and voltage scaling (DCVS) controller.

16. The system of claim 9, wherein the means for initiating the adjustment of the operating parameter for processing the burst of packets comprises: means for waking-up a system cache.

17. A system for processing wireless download data in a portable communication device, the system comprising:
a central processing unit (CPU), a wireless communication processor, and a dynamic clock and voltage scaling (DCVS) controller electrically coupled via a system bus;
the wireless communication processor configured to:
receive incoming packet data via a wireless communication network;
generate and insert burst metadata into a burst of packets comprising a portion of the incoming packet data, the burst metadata specifying one or more workload parameters associated with the burst of packets; and
transmit the burst metadata and the burst of packets to the CPU; and
the DCVS controller configured to adjust a frequency of the CPU for processing the burst of packets in accordance with the one or more workload parameters in the burst metadata.

18. The system of claim 17, further comprising a cache controller electrically coupled to the CPU, the cache controller configured to wake up and adjust a frequency of a system cache in response to the one or more workload parameters in the burst metadata.

19. The system of claim 17, further comprising a memory controller electrically coupled to the DCVS controller via the system bus, the memory controller configured to adjust a frequency of a memory bus in response to the one or more workload parameters in the burst metadata.

20. The system of claim 17, wherein the wireless communication processor comprises a modem processor and the wireless communication network comprises a wireless wide area network.

21. The system of claim 17, wherein the burst of packets has a predetermined rate of received packets.

22. The system of claim 17, wherein the one or more workload parameters comprises one or more of a time-sensitivity parameter, a data size, a recommended number of instructions per second, and a download duration.

23. The system of claim 1, wherein the burst metadata is transmitted to the CPU via an out-of-band channel and the burst of packets is transmitted to the CPU via an in-band channel.

24. A computer program embodied in a computer readable medium and executed by a processor for processing wireless download data in a portable communication device, the computer program comprising logic configured to:
receive incoming packet data via a wireless communication network;
generate and insert burst metadata into a burst of packets comprising a portion of the incoming packet data, the burst metadata specifying one or more workload parameters associated with the burst of packets; and
send the burst metadata and the burst of packets to a central processing unit (CPU); and
initiate an adjustment of an operating parameter for processing the burst of packets in accordance with the one or more workload parameters in the burst metadata.

25. The computer program of claim 24, wherein the wireless communication network comprises a wireless wide area network.

26. The computer program of claim 24, wherein the burst of packets has a predetermined rate of received packets.

27. The computer program of claim 24, wherein the one or more workload parameters comprises one or more of a time-sensitivity parameter, a data size, a recommended number of instructions per second, and a download duration.

28. The computer program of claim 24, wherein the burst metadata is transmitted to a central processing unit (CPU) via an out-of-band channel and the burst of packets is transmitted to the CPU via an in-band channel.

29. The computer program of claim 24, wherein the operating parameter for processing the burst of packets comprises one of a CPU frequency and a memory bus frequency.

30. The computer program of claim 24, wherein the adjustment of the operating parameter for processing the burst of packets in accordance with the one or more workload parameters in the burst metadata comprises:
waking up a system cache; and
increasing the system cache frequency.
